(19) United States
(12) Patent Application Publication
(10) Pub. No.: US 2005/0227158 A1
(43) Pub. Date: Oct. 13, 2005

(54) Toner for producing wiring board and method of producing wiring board using thereof

(75) Inventors: Toshiaki Yamauchi, Fujisawa-shi (JP); Koji Imamiya, Kawasaki-shi (JP); Hiroshi Hashizume, Tokyo (JP); Hideo Aoki, Tokyo (JP); Naoko Yamaguchi, Tokyo (JP); Chiaki Takubo, Tokyo (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/081,029

(22) Filed: Mar. 16, 2005

(30) Foreign Application Priority Data
Apr. 7, 2004 (JP) 2004-113466
Apr. 7, 2004 (JP) 2004-113465

(51) Int. Cl. G03G 9/08; G03G 15/20

(52) U.S. Cl. 430/108.1; 430/109.1; 430/124; 430/109.2

(57) ABSTRACT

A conductive underlayer is formed in an electrophotographic manner using a toner comprising toner particles containing a binder resin containing a green thermosetting resin and conductive particles having an average particle diameter of 0.05 μm to 1 μm, wherein 50% by volume particle diameter of the toner is in a range 4 μm to 12 μm and the ratio of the toner with a size of 4 μm or smaller is 20% by number or less, or a toner including external additives containing hydrophobic-treated small size metal oxide particles having a BET specific surface area of 150 m²/g to 400 m²/g and large size metal oxide particles having a BET specific surface area of 10 m²/g to 70 m²/g and then a conductive layer is formed thereon by plating.

### CROSS-REFERENCE TO RELATED APPLICATIONS

This application is based upon and claims the benefit of priority from prior Japanese Patent Applications No. 2004-113465, filed Apr. 7, 2004; and No. 2004-113466, filed Apr. 7, 2004, the entire contents of both of which are incorporated herein by reference.

### BACKGROUND OF THE INVENTION

1. Field of the Invention

The invention relates to a technique of producing a wiring board in an electrophotographic manner, particularly to a toner suitable for the production technique.

2. Description of the Related Art

Conventionally, as a method of forming a circuit pattern on a substrate composing a wiring board or multilayered wiring board, a screen printing method has been employed widely. The screen printing method comprises producing a paste by mixing a metal powder such as silver, platinum, copper, palladium, or the like with a binder such as ethyl cellulose and adjusting the viscosity with a solvent such as terpineol, tetralin, butyl carbitol, or the like and applying the paste in a predetermined circuit pattern to a substrate.

However, the screen printing method requires masks exclusive for the respective circuit patterns to be made ready and particularly in the case of producing multilayered wiring boards that tend to be manufactured in large-item-small-scale production, types of masks needed for exclusive use increase to result in problems that it takes a long time to produce the masks for exclusive use and it costs considerably high to produce the multilayered wiring boards. Further, even in the case of partial alteration of a circuit pattern, a-mask for exclusive use has to be produced again and the method is thus inflexible to take a countermeasure for such a case.

To solve such problems of the screen printing method, in recent years, methods for forming circuit patterns on substrate in an electrophotographic manner have been developed. For example, Jpn. Pat. Appln. KOKAI Publication No. 2001-284769 discloses a method for forming a circuit pattern by producing a toner for producing a wiring board by firmly sticking a charge control agent to the surface of a spherical conductive powder and further coating the powder with a thermoplastic resin; electrostatically attaching the toner to an electrostatic latent image in a predetermined pattern formed on a photoconductor, developing the latent image to a visible image, namely, carrying out development process; and transferring the visible image to a substrate.

However, such a toner for producing a wiring board to be used for the electrophotographic manner has a thermoplastic resin layer thin as composed with that of a common toner for copying and therefore the electric resistance of the toner is low and the charging capacityability is deteriorated to easily cause fogging and even if an external additives are added, it is very difficult to control the charging capacity of the toner so that formation of the circuit pattern in a high precision is very difficult.

As described, in the case of forming a circuit pattern in an electrophotographic manner, the chargeability for development and the conductivity as the circuit pattern are mutually in contradicting relation and therefore, there occurs a problem that the control is very difficult. Particularly, in order to form a fine pattern just like the circuit pattern with a high precision, control of the chargeability is extremely important and thus industrial production of a toner for producing a wiring board which satisfies both requirements of high circuit pattern precision and electric properties is very difficult.

### BRIEF SUMMARY OF THE INVENTION

In view of the above-mentioned state of the art, the invention aims to provide a toner for a wiring board production which is usable for easy and large-item-small-scale production of wiring boards at low cost, has a stable chargeability and hardly causes fogging, and is capable of forming circuit patterns at high precision.

The invention provides at first a wiring board production technique including forming a conductor underlayer by an electrophotographic manner and forming a conductor layer thereon by plating and a toner to be use for forming the conductor underlayer in the wiring board production comprises toner particles each containing a binder resin containing a green thermosetting resin as a main component and 15% to 70% by weight of conductive particles having an average particle diameter in a range of 0.05 μm to 1 μm and 50% by volume of the toner has a particle diameter in a range 4 μm to 12 μm and the ratio of the toner with a size of 4 μm or smaller is 20% by number or less.

The invention provides secondarily a wiring board production technique including forming a conductor underlayer by an electrophotographic manner and forming a conductor layer thereon by plating and a toner to be use for forming the conductor underlayer in the wiring board production comprises toner particles each containing a binder resin containing a green thermosetting resin as a main component, 15% to 70% by weight of conductive particles having an average particle diameter in a range of 0.05 μm to 1 μm, and as external additives to the toner particles, first small size metal oxide particles having a BET specific surface area of 150 m²/g to 400 m²/g and treated to be hydrophobic and second large size metal oxide particles having a BET specific surface area of 10 m²/g to 70 m²/g and having a larger average particle diameter than that of the first small metal oxide particles.

Additional objects and advantages of the invention will be set forth in the description which follows, and in part will be obvious from the description, or may be learned by practice of the invention.

The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing one example of a toner according to the first embodiment.

FIG. 2 is a schematic view showing one example of a toner according to the second embodiment.

FIG. 3 is a schematic view showing one example of a wiring board production apparatus of an electrophotographic manner.

FIG. 4 is a schematic view showing another example of the wiring board production apparatus of an electrophotographic manner.

FIG. 5 is a schematic cross-sectional view explaining one example of a production process of a wiring board according to the invention.

FIG. 6 is a schematic cross-sectional view explaining another example of a production process of a wiring board according to the invention.

FIG. 7 is a schematic cross-sectional view explaining further another example of a production process of a wiring board according to the invention.

### DETAILED DESCRIPTION OF THE INVENTION

The toner according to the first embodiment of the invention is a toner comprising toner particles each containing a binder resin and conductive particles, in which the binder resin contains a green thermosetting resin as a main component: the conductive particles have an average particle diameter of 0.05 μm to 1 μm and are contained in 15% to 70% by weight in the entire weight of the toner particles: 50% by volume particle diameter of the toner is in a range 4 μm to 12 μm and the ratio of the toner with a size of 4 μm or smaller is 20% by number or less.

The toner according to the second embodiment of the invention is a toner comprising toner particles each containing a binder resin, conductive particles, and external additives added externally to the toner particles, in which the binder resin contains a green thermosetting resin as a main component: the conductive particles have an average particle diameter of 0.05 μm to 1 μm and are contained in 15% to 70% by weight in the entire weight of the toner particles: the external additives contain small size metal oxide particles having a BET specific surface area of 150 m²/g to 400 m²/g and treated to be hydrophobic and large size metal oxide particles having a larger average particle diameter than that of the small size metal oxide particles.

The BET specific surface area means specific surface area measured by an isothermal BET adsorption method.

The green thermosetting resin means the resin is not heat-cured yet.

Hereinafter, the invention will be described more in detail with reference to drawings.

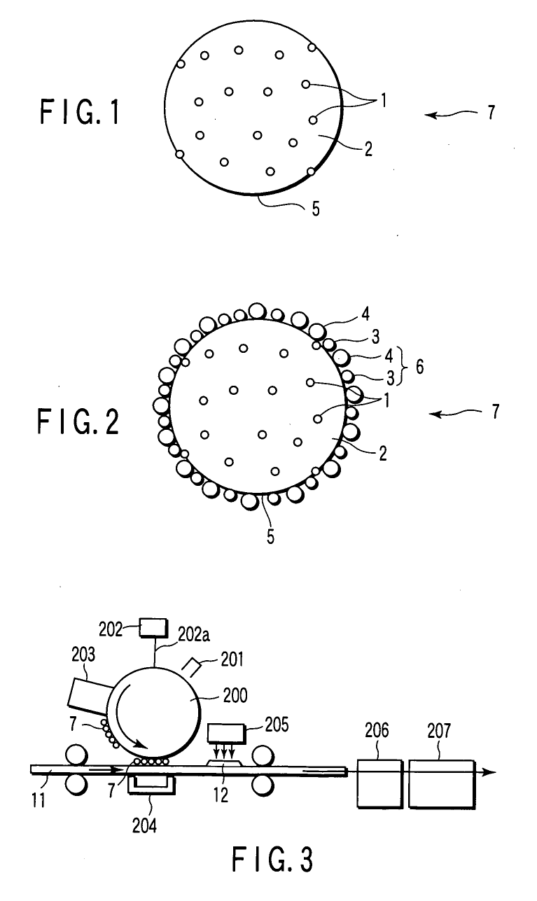

FIG. 1 is a schematic view showing one example of a toner according to the first embodiment.

As shown in the drawing, the toner 7 has toner particles 5 each containing a binder resin 2 containing a green thermosetting resin as a main component and conductive particles 1 of a metal such as copper dispersed in the binder resin

FIG. 2 is a schematic view showing one example of a toner according to the second embodiment.

As shown in the drawing, the toner 7 has toner particles 5 each containing a binder resin 2 containing a green thermosetting resin as a main component and conductive particles 1 of a metal such as copper dispersed in the binder resin, and external additives 6 externally added and attached to the surface of the toner particles 5. The external additives 6 contain small size metal oxide particles 3 and large size metal oxide particles 4.

In the invention to form a conductive underlayer of a wiring board, a toner containing toner particles comprising a binder resin containing a green thermosetting resin as a main component and 15% to 70% by weight of conductive particles having an average particle diameter of 0.05 μm to 1 μm is used.

As shown in FIG. 1 and FIG. 2, with respect to such toner particles 5, the chargeability required for the toner tends to be easily assured since the amount of the conductive particles 1 appearing on the surface of the toner particles 5 is small at the time of development in an electrophotographic manner.

However, the thermosetting resin to be used such as an epoxy resin has more functional groups than those of a thermoplastic resin such as styrene type resin and polyester type resin to be used conventionally for an electrophotographic toner so that the thermosetting resin tends to lose the charge capacity by moisture absorption in particularly humid environments. Under the condition that the electric resistance of the toner is low and the charging capacity is low, so-called fogging which is a phenomenon that the toner develops even a part where no electrostatic latent image of an electrophotograph exists can be easily caused. Also, at the time of development, since the thermosetting resin in the toner particles is not yet cured, the toner cannot keep sufficient strength as compared with a conventional toner and is possibly broken and deteriorated easily by stirring by a developing apparatus and accordingly generated toner fine powder may cover the carrier to result in inhibition on charging and development and it can be also a cause of fogging. As described, although the toner is made capable of developing a precise circuit pattern by being made fine, the toner has a disadvantage that the toner fine powder is increased to easily cause fogging. Further, if such fogging occurs, the toner adheres to a part other than the developed circuit pattern to lead to a risk of occurrence of short-circuit.

As a method for suppressing the fogging attributed to low resistance and low charging capacity, it may be possible to add charge control agent (CCA) to increase the charging capacity, however just like the toner particles to be used in the invention, even if CCA is added similarly to the case of a common electrophotographic toner to toner particles containing conductive particles and the thermosetting resin and having a low resistance and high moisture absorption, it only causes insufficient effect and further, a common CCA is often a thermally decomposable substance and such a CCA is not desirable to be added in a large quantity to the toner for producing a wiring board in the case of providing sufficient reliability as a circuit.

Also, as means for increasing the charging capacity, means for adding external additives such as silica is also well known, however even if external additives are added similarly to the case of a common electrophotographic toner, it is insufficient for the charge control and if the covering ratio of the toner is increased to a certain extent or further by addition of an excess amount of the additives, silica is isolated and adheres to the carrier to cause an adverse effect that the charging capacity is contrarily decreased.

According to the first embodiment of the invention, stable chargeability is obtained, fogging is suppressed and a conductive underlayer for forming a conductive pattern can be formed by adjusting the 50% by volume particle diameter of the toner containing toner particles which comprise the thermosetting resin and conductive particles and whose chargeability is hardly stabilized to be 4 μm to 12 μm and adjusting the toner particles with 4 μm or smaller to be in 20% by number or less.

According to the second embodiment of the invention, stable chargeability can be obtained, fogging can be suppressed and a conductive underlayer for forming a conductive pattern can be formed by using external additives containing small size metal oxide particles having a BET specific surface area of 150 m²/g to 400 m²/g and treated to be hydrophobic and large size metal oxide particles having a BET specific surface area of 10 m²/g to 70 m²/g for the toner containing toner particles which comprise the thermosetting resin and conductive particles and whose chargeability is hardly stabilized.

In general, large size metal oxide particles with a fine particle diameter and a high BET specific surface area give high charging capacity to a toner. Increase of the addition amount further increases the charging capacity and improves the fluidity and covering the toner surface with the metal oxide particles increases the strength at the time of stirring as a developer and suppresses increase of a toner fine powder and a spent toner. However, as described above, excess addition contrarily causes a problem of charging capacity deterioration owing to carrier pollution.

On the other hand, in the case small size metal oxide particles with a large particle size and a small BET specific surface area are added, the particles are supposed to work as balls or spacers to increase the effect to suppress increase of a toner fine powder and increase of a spent toner as compared with particles with a small particle size, however they are less effective to increase the charging capacity owing to the narrow effective surface area. Further, if the addition amount is increased, it results in adverse effects of abrading a photoconductor and shortening the life of the photoconductor.

Accordingly, effective combination of the external additives has been investigated to find, as shown in the second embodiment of the invention, that addition of both of metal oxide particles with a large BET specific surface area and treated to be hydrophobic and metal oxide particles with a small BET specific surface area gives good chargeability and long service life, suppresses fogging, and improves the pattern precision.

As the small size metal oxide particles, those having a BET specific surface area in a range of 150 m²/g to 400 m²/g and treated to be hydrophobic are used. The BET specific surface area is preferably in a range of 150 to 300 m²/g and more preferably in a range of 160 to 250 m²/g. If it is lower than 150, the charging capacity cannot be increased sufficiently and fogging tends to be increased. If it exceeds 300 m²/g, the charging capacity tends to be increased and fluctuated during the life.

The small size metal oxide particles are preferable to have an average particle diameter of 5 to 15 nm.

The addition amount of the small size metal oxide particles is preferably 0.3 to 1.5% by weight. If it is less than 0.3% by weight, it tends to be difficult to give efficient charging capacity and fluidity and if it exceeds 1.5% by weight, on the contrary, it tends to decrease the charging capacity owing to carrier pollution and cause fogging.

As the large size metal oxide particles, those having a BET specific surface area in a range of 10 m²/g to 70 m²/g are used. The BET specific surface area is preferably in a range of 20 m²/g to 60 m²/g. If it is lower than 10 m²/g, the particles become difficult to adhere evenly to the toner because of the large particle diameter and tend to scratch the photoconductor and if it exceeds 70 m²/g, the effect to suppress the spent toner generation tends to be lowered.

Further, the large size metal oxide particles are preferable to have an average particle diameter larger than that of the small size metal oxide particles and in a range of 25 to 100 nm. The difference of the average particle diameter of the large size metal oxide particles and the small size metal oxide particles is preferably 10 to 50 nm.

The addition amount of the large size metal oxide particles is preferably 0.5 to 2.0% by weight. If it is less than 0.5% by weight, the effect to suppress the fine powder and spent toner increase tends to be lowered and if it exceeds 2.0% by weight, it tends to decrease the charging capacity owing to carrier pollution and shorten the life of the photoconductor.

The toner particles containing the thermosetting resin and conductive particles, particularly metal particles, tend to scratch and wear the photoconductor with the hard metal particles, considerably shorten the life of the photoconductor, and produce defective images with fogging, ghost, and strings.

According to the invention, a metal soap powder is further added preferably as external additives to provide a toner for producing a wiring board which can maintain good images and scarcely deteriorates the photoconductor even after repeated image outputs.

Further, according to the invention, since a portion of the conductive particles dispersed in the conductive underlayer formed using the toner exist on the toner surface, a uniform conductor layer covering the entire toner pattern using the exposed conductive particles as cores is formed by electroless plating with a conductive material after formation of a circuit pattern of the toner on a substrate and thermal curing of the toner.

Further, according to the invention, even if the conductive underlayer pattern formed using the toner does not have sufficient conductivity, successive formation of the plating layer gives the conductive layer including the conductive particles and the plating layer and therefore, unlike the case that the conductive layer is formed only using the toner, the quantity of the conductive particles in the toner can be saved. Consequently, the chargeability of the toner is improved and excellent patterns with little fogging can be developed.

The thermosetting resin to be used as the binder resin may include, for example, phenol resin, melamine resin, furan resin, epoxy resin, unsaturated polyester resin, diallyl phthalate resin, and polyimide resin. As a binder resin for a common toner for electrophotography, thermoplastic resin melted by heating is generally used, whereas as the binder resin for the toner for a wiring board of the invention, since it is required that the conductive pattern of the circuit on which the toner is mounted is stable even against heating, thermosetting resin is used.

As a material for the substrate, a glass-epoxy substrate, a bakelite substrate (phenol resin), or the like can be used. As a material for the toner, epoxy resin, phenol resin, or their mixture is more preferable to be used so as to have a high compatibility with these substrates.

The toner is basically composed by dispersing 15 to 75% by weight of conductive particles with an average particle diameter of 0.05 μm to 1 μm in the green thermosetting resin. As the conductive particles, transition metal particles of such as Cu, Ni, Co, Ag, Pd, Rh, Au, Pt, Ir and the like are preferably used.

The content of the conductive particles is 15 to 75% by weight, preferably 30 to 65% by weight, in the total weight of the toner particles. If the content of the conductive particles exceeds 75% by weight, the electric resistance of the toner is decreased to lower the chargeability and cause fogging and if the content of the conductive particles is lower than 15% by weight, the amount of the conductive particles appearing on the surface of the toner particles to be cores at the time plating decreases and therefore even if plating is carried out successively, the circuit pattern to be formed is provided with insufficient conductivity.

The particle diameter of the conductive particles can be in a range of 0.05 to 1 μm, preferably in a range of 0.1 to 1 μm, and more preferably in a range of 0.2 to 0.7 μm. If the particle diameter of the conductive particles exceeds 1 μm, the conductive particles are insufficiently dispersed in the binder and the metal fine powder particles exposed and isolated on the toner surface exist more to generate fogging. On the other hand, if the particle diameter of the conductive particles is smaller than 0.05 μm, uniform dispersion of the conductive particles tends to be difficult.

As the conductive material for the plating, transition metals such as Cu, Ni, Co, Ag, Pd, Rh, Au, Pt, Ir, and the like can be employed.

The combination of the conductive materials for the plating and conductive particles for the toner may be of both similar and dissimilar materials. Preferable combinations can be Cu in combination with Cu; Cu with Pd; Pd with Pd; Cu with Ni; and Ni with Pd. Since economical and highly conductive, Cu can be preferably used. Also, palladium can be used preferably since it can work as a catalyst for promoting the plating reaction.

The toner of the invention may contain wax, a dispersion assisting agent, a coloring agent, and a charge control agent (CCA), based on the necessity.

As a method of producing the toner of the invention, there is, for example, a melting and kneading method. The melting and kneading method involves evenly mixing raw materials including the thermosetting resin and conductive particles; heating and kneading the mixture by using a kneading apparatus such as a pressurizing kneader, a Bumbury's mixer, and a two-roll, three-roll, or biaxial extruder; cooling and successively coarsely crushing the kneaded mixture; finely crushing the coarsely crushed mixture; and separating the obtained particles by air blow separation apparatus to give toner particles with adjusted particle diameter distribution. Additionally, at the time of production, particularly at the time of heating and kneading, the temperature and the duration can carefully be controlled so as not to cure the thermosetting resin.

The toner according to the first embodiment may contain external additives on the toner particle surface.

Also, the toner according to the second embodiment may contain external additives on the toner particle surface.

As an external addition method of the external additives, there is a method of sticking the additives to the toner particle surface by a mixing apparatus such as a Henshel mixer and sieving the toner particles through a sieve if necessary to obtain a toner.

As the external additives, metal oxides such as silicon oxide (silica), titanium oxide, alumina, zirconium oxide, zinc oxide, tin oxide, germanium oxide, or gallium oxide can be exemplified. To provide negative chargeability, silica is preferable to be added.

The external additives to be used for the toner according to the second embodiment are small size metal oxide particles having a BET specific surface area of 150 m²/g to 400 m²/g and treated to be hydrophobic and large size metal oxide particles having a BET specific surface area of 10 m²/g to 70 m²/g. The external additives to be used for the toner according to the second embodiment may also be added preferably to the toner particle surface of the toner according to the first embodiment. Accordingly, not only negative chargeability and also toner flowability and attaching properties can be improved.

Further, as these metal oxides, those surface-treated to be hydrophobic for preventing the charging capacity decrease under high humidity condition are used. As a surface treatment agent, for example, dimethyldichlorosilane, hexamethyldisilazane, alkylsilane, dimethylpolysiloxane, and octamethylcyclosiloxane can be used.

As an external additive, further addition of a metal soap suppresses mechanical stress of the photoconductor with a developer or a cleaning member and prolongs the life of the photoconductor. As such a metal soap, for example, non-alkali metal salts of fatty acids such as zinc stearate, calcium stearate, magnesium stearate, aluminum stearate, zinc laurate or the like are used preferably and zinc stearate can be more preferable to be added in an amount of 0.01 to 1.0% by weight in the total weight of the toner. The average particle diameter of the metal soap can be preferably 0.2 μm to 6 μm and more preferably 1 μm to 5 μm.

The particle diameter of the toner according to the first embodiment is 4 μm to 12 μm, preferably 5 μm to 10 μm, more preferably 6 μm to 9 μm as the 50% by volume particle diameter. The existence ratio of particles with 4 μm or smaller is preferably 0 to 20% by number and more preferably 0 to 16% by number.

The particle diameter of the toner according to the second embodiment is preferably similar to that of the toner according to the first embodiment.

If the particle diameter of the toner is lager than 12 μm, the resolution of a circuit pattern cannot be increased and it is possible that the electric communication of the circuit is insufficient owing to the voids among the toner particles. If the existence ratio of the particles with 4 μm or smaller exceeds 20% by number, the developing property is deteriorated and fogging tends to be increased. It is supposedly attributed to that if the particle diameter of the toner is small, the coverage of the carrier is increased and the toner covering the carrier tends to inhibit charging of the toner added further and also the conductive particles tend to be separated from the toner and that the resistance of the toner is decreased to lower the charging capacity if such separated conductive particles exist many among toner particles. Therefore, at the time of toner production, particularly, the crushing and separating process, it is preferable to adjust the toner so as to decrease the fine powder amount. However, such adjustment is contradictory to the yield and productivity of the toner and therefore, it is no need to decrease the fine powder to an extreme extent. Based on the results of investigations on the relation of the fine powder amount of the toner and fogging, it is found that suppression of the fine powder amount to the range is effective to obtain a good toner image with little fogging.

It is also important to suppress decrease of the electric resistance of the toner in terms of toner image formation in an electrophotographic manner. The toner bears charging capacity by friction charging and the charging capacity is a source of electric power governing the development or transfer process. If the electric resistance is low, the charge easily leaks and therefore the charging capacity decreases and the toner easily accepts charging capacity injection from the electric field between the photoconductor and the developing apparatus to result in further decrease of the effective charging capacity at the time of development and consequently, fogging tends to be caused easily. In this invention, addition of the conductive particles and use of the thermosetting resin having many functional groups lower the electric resistance as compared with a conventional toner for electrophotography and the resistance value is controlled to be preferably 1×10¹⁰ Ωcm or higher and more preferably 1×10¹⁰ Ωcm to 50×10¹⁰ Ωcm or higher, so that clear images free from fogging tend to be obtained.

A method of producing the wiring board according to the third embodiment of the invention is a method comprising a step of forming a circuit pattern in an electrophotographic manner using the toner according to the first embodiment and comprises a step of forming a toner image by developing an electrostatic latent image using the toner; a step of forming a conductive underlayer by setting the green thermosetting resin by transferring the obtained toner image to a substrate and then heating the toner image; and a step of forming a conductive layer by forming a plating layer on the conductive underlayer by plating a conductive material.

Further, a method of producing the wiring board according to the fourth embodiment of the invention is the same method as the method of producing the wiring board according to the third embodiment, except that the production method of the fourth embodiment further involves a step of forming a circuit pattern in an electrophotographic manner using the toner according to the second embodiment.

One example of the method of producing the wiring board according to the third embodiment will be described with reference to FIG. 3 to FIG. 7.

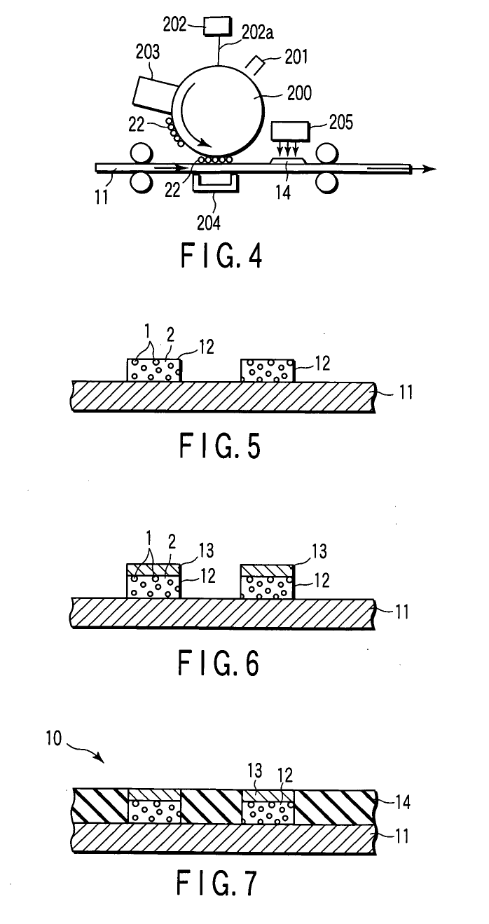

FIG. 3 is a schematic view showing one example of a wiring board production apparatus of electrophotographic manner using the toner according to the first embodiment of the invention. FIG. 4 is a schematic view showing another example of the wiring board production apparatus according to the invention. FIG. 5 is a schematic cross-sectional view showing one example of a production process of a wiring board according to the invention. FIG. 6 is a schematic cross-sectional view showing another example of a production process of a wiring board according to the invention. FIG. 7 is a schematic cross-sectional view explaining further another example of a production process of a wiring board according to the invention.

The production apparatuses shown in FIG. 3 and FIG. 4 are apparatuses for forming a conductive pattern and forming an insulating pattern using the toner of the invention and each comprises a photoreceptor drum 200, a charging unit 201, a laser generation and scanning unit 202, a developing unit 203, a transferring unit 204, a substrate 11 for wiring board production, and a heating or light irradiating resin setting unit 205 and the apparatus shown in FIG. 3 further has a resin etching unit 206 and an electroless plating bath 207.

In a conductive pattern formation process, at first, while the photoreceptor drum 200 being rotated in the direction pointed by an arrow, the surface potential of the photoreceptor drum 200 is evenly charged at a predetermined potential (e.g. negative charge) by the charging unit 201. As a practical charging method, for example, Scorotron type charging method, roller charging method, and brush charging method can be exemplified. Next, laser beam 202a is radiated to the photoreceptor drum 200 by the laser generation and scanning unit 202 depending on the image signals to remove the negative charge in the radiated portions and an image (an electrostatic latent image) of a predetermined conductive underlayer pattern on the surface of the photoreceptor drum 200.

Next, a charged toner 7 for wiring board production containing conductive particles of such as copper or palladium and a green thermosetting resin, having the constitution same as shown in FIG. 1, and stored in the developing unit 203 is attached electrostatically to the electrostatic latent image on the photoreceptor drum 200 by a supply mechanism to visualize the image. In this case, a positive development method or a negative development method can be employed. For the developing unit 203, a well-known dry or wet toner transferring technique in an electrophotographic copying system can be employed.

In the case the developing unit 203 is of a dry development type, a toner 7 having 50% by volume particle diameter not smaller than 4 μm and smaller than 12 μm and of which the ratio of toner particles with 4 μm or smaller size is 20% by number is stored. The toner 7 preferably has 50% by volume particle diameter in a range of 5 to 10 μm.

Successively, the visible image (the pattern) formed on the photoreceptor drum 200 by the toner 7 is electrostatically transferred to a desired substrate 11 from the photoreceptor drum 200 by the transferring unit 204. In the photoreceptor drum 200 after the transfer, the toner 7 remaining on the photoreceptor drum is removed and recovered by a cleaning unit not illustrated.

Next, the toner 7 transferred to the substrate 11 is passed through the heating or light irradiating resin setting unit 205 to melt and cure the green thermosetting resin 2 contained in the toner 7. Accordingly, as shown in FIG. 5, the conductive underlayer 12 of the desired pattern in which the toner 7 is united is formed on the substrate 11.

The conductive underlayer 12 has no conductivity and therefore the conductive underlayer 12 is immersed in a Cu electroless plating bath 207 to selectively precipitate Cu using the conductive particles 1 as cores and obtain a conductive layer containing the conductive particles 1 of the conductive underlayer 12 and the plating layer 13 as shown in FIG. 6. In such a manner the conductive pattern having good conductivity can be formed. Additionally, in this case, although the plating bath shown in the drawing comprises only the electroless plating bath 207, it is not limited such a plating bath and a plating bath capable of carrying out both electroless plating and electrolytic plating may be used.

Further, to efficiently carry out the electroless plating, for example, as shown in the drawing, treatment for extruding at least portions of the metal particles 1 on the surface of the conductive underlayer 12 may be carried out in the resin etching unit 206 before the plating treatment of the conductive underlayer 12. The resin etching unit 206 is for removing a portion of the resin in the surface of the conductive underlayer 12 by etching and the resin etching unit 206 carries out chemical etching and removal of the surface of the conductive underlayer 12 by immersing the conductive underlayer 12 in a solvent such as acetone or an acidic or alkaline etching solution. Further, the resin etching unit 206 is capable of carrying out mechanical etching by polishing by shot blast or air blast method other than chemical etching.

In the case the conductive underlayer 12 is incompletely cured state, use of an alkaline etching solution makes it possible to remove the resin in the surface of the conductive underlayer 12 during plating and carry out plating treatment so that etching removal by the resin etching unit 206 is made unnecessary. The thickness of the conductive metal layer 13 to be formed on the surface of the conductive underlayer 12 can be controlled by the plating conditions. After plating treatment, to close adhesion of the substrate 11 and the conductive underlayer 12 and prevent separation, it is preferable to completely cure the conductive underlayer 12 by heating or radiating light by the resin setting unit 205.

Next, with reference to FIG. 4, an insulating pattern formation process will be described. At first, while the photoreceptor drum 200 being rotated in the direction pointed by an arrow, the surface potential of the photoreceptor drum 200 is evenly charged at a predetermined potential (e.g. negative charge) by the charging unit 201. Next, laser beam 202a is radiated to the photoreceptor drum 200 by the laser generation and scanning unit 202 depending on the image signals to remove the negative charge in the radiated portions and an charging capacity image (an electrostatic latent image) of a predetermined pattern on the surface of the photoreceptor drum 200.

Next, resin particles 22 stored in the developing unit 203 and bearing charging capacity are attached electrostatically to the electrostatic latent image on the photoreceptor drum 200 by a supply mechanism to visualize the image. In this case, a normal development method or a reverse development method can be employed. For the developing unit 203, a well-known dry or wet toner transferring technique in an electrophotographic copying system can be employed.

In the case the developing unit 203 is of a dry development type, resin particles 22 with a particle diameter of 3 μm to 50 μm are stored in the developing unit 203. The resin particles 22 are preferable to have a particle diameter of 8 μm to 15 μm. On the other hand, in the case the developing unit 203 is of a wet development type, resin particles 22 with a particle diameter of 3 μm or smaller are stored in the developing unit 203. In the insulating pattern formation, the insulating layer is desirable to be thick from a viewpoint of the electric insulation property and the particle diameter of the resin particles 22 is larger than the toner for producing a wiring board.

As the resin for composing the resin particles 22, a green thermosetting resin solid at a normal temperature can be used. As the green thermosetting resin, epoxy resin, polyimide resin, and phenol resin can be used and if desirable, a charge control agent may be added. Further, silica fine particles may be dispersed at a predetermined ratio in the resin particles 22 and consequently, the properties such as rigidity and thermal expansion coefficient can be controlled in the multilayered wiring board and thus the reliability of the board can be improved.

Successively, the visible image (the pattern) formed on the photoreceptor drum 200 by resin particles 22 is electrostatically transferred to a desired substrate 11 from the photoreceptor drum 200 by the transferring unit 204. In the photoreceptor drum 200 after the transfer, the resin particles 22 remaining on the surface are removed and recovered by a cleaning unit not illustrated.

Next, the resin particles 22 transferred to the substrate 11 is passed through the heating or light irradiating resin setting unit 205 to melt and cure the green thermosetting resin 2 and an insulating layer 14 of the unified and cured thermosetting resin is formed as shown in FIG. 7.

In such a manner, an insulating pattern sufficiently excellent thermal, mechanical, and environment-durable properties is formed on the substrate 11 for the wiring board. In both steps of the conductive pattern formation and the insulating pattern formation, the resin mainly containing the green thermosetting resin can easily be removed by a solvent or the like if before being cured by heating or light radiation and therefore, pattern removal or amendment is possible.

Further, one example of the production process of the wiring board according to the fourth embodiment may comprise the same production steps as those of the exemplified production process of the wiring board according to the third embodiment, except that the toner having an average particle diameter of 3 to 50 μm according to the second embodiment is stored in the developing unit 203 shown in FIG. 3 and in this case the particle diameter of the toner is preferably 5 to 10 μm.

According to the method of the invention, the wiring board can be formed without using an exposure mask by successively carrying out a step of forming a conductive layer by forming a conductive underlayer containing conductive particles in an electrophotographic manner and carrying out electroless plating on the conductive underlayer and a step of forming an insulating layer using resin particles similarly in an electrophotographic manner.

Further, the wiring board is formed directly from designed digital data so that the cost can be saved and the production time can be shortened. Further, the method of producing the wiring board according to the invention is suitable for large-item-small-scale production.

Further, it is no need to use photosensitive resin as the resin for forming the pattern and also printability relevant to thixotropy and viscosity is not particularly needed, the physical property values of the resin (e.g. Young's modulus, glass transition temperature Tg, moisture absorption property) are highly optional and as a result, the reliability can be improved. Further, since the thermosetting resin to be used has good thermal properties after curing, the heat resistance is so high as to stand for the normal soldering temperature (about 220 to 260° C.) for the obtained wiring board.

Further, a low cost circuit substrate (e.g. a build-up substrate) produced by a conventional method may be used as the substrate and the conductive pattern may be formed by the method according to the invention.

As described, according to the invention, chargeability is stabilized, fogging is scarcely caused, the wiring board having a circuit pattern with a high precision is produced. Further, according to the invention, large-item-small-scale production of wiring boards can easily be carried out at a low cost.

In this specification, the method of transferring the toner for producing a wiring board or resin particles electrostatically to the substrate by the transferring unit in an electrophotographic manner is described as the conductive pattern and insulating pattern formation process, however the formation process should not be limited to the transferring method. For example, in place of the transferring unit, an intermediate transfer drum and an intermediate transferring body heating unit may be disposed in the production apparatus and the conductive underlayer or the resin layer softened by the intermediate transferring body heating unit is brought into contact with and pressurized to the desired substrate from the intermediate transfer drum while being in softened state to transfer the layer owing to the viscid property of the conductive underlayer or the resin layer.

Further, the formation processes of the conductive pattern and the insulating pattern are repeated by employing the technique of the invention to form the multilayered wiring board.

Hereinafter, the invention will be described more in detail with reference to Examples.

At first, an example of a toner according to the first embodiment and one example of a method of producing a wiring board according to the third embodiment using the toner will be described.

### EXAMPLE 1

A thermosetting epoxy resin 50 part by weight as a binder and copper particles with a volume average particle diameter of 0.6 μm 50 part by weight as conductive particles were evenly mixed by a Henshel mixer for 5 minutes to obtain a mixture. The mixture was kneaded at 90° C. for 10 minutes by a pressurizing kneader for gelation and then quenched to obtain a kneaded product. The obtained kneaded product was coarsely crushed to 2 mm or smaller by a hammer mill. After that, the coarsely crushed particles are pulverized and sieved to about 8.0 μm by I type jet pulverizer and DSX sieving apparatus to obtain toner particles.

The obtained toner particles 100 part by weight were mixed with silica R 974 (manufactured by Degussa, average particle diameter 12 nm, dimethyldichlorosilane-surface treated) 1 part by weight and silica NAX 50 (manufactured by NIPPON AEROSIL CO., LTD., average particle diameter 35 nm, hexamethyldisilazane-surface treated) 1 part by weight by a Henshel mixer for 10 minutes and sieved with 200 mesh to obtain a toner.

Measurement of Particle Distribution

With respect to the obtained toner, the toner particle size distribution was measured using Multisizer II manufactured by Coulter to find that the 50% by volume particle diameter was 8.0 μm and the ratio of particles with 4 μm or smaller was 3.5% by number.

Measurement of Intrinsic Volume Resistivity

Further, the intrinsic volume resistivity of the toner was measured using AG-4311 LCR meter manufactured by Ando Electric Co., Ltd. by forming a pellet with a thickness of about 1.5 mm by 30t pressure and applying 1 kHz-5V a.c. current at 30° C. to find it was 2.9×10¹⁰ Ωcm.

The above-described toner was set in e-Studio 450 of MFP manufactured by TOSHIBA TEC CORPORATION out of which the fixing unit was taken and printing data for a conductive underlayer was output, transferred to a glass epoxy substrate and then the toner was heated and cured and fixed by heating for 10 minutes by a hot plate at 160° C. to obtain a substrate bearing the conductive underlayer. For evaluation, transfer and fixation process was carried out similarly on a sheet of ordinal paper to obtain an ordinal paper sample on which the conductive underlayer was formed.

The conductive underlayer pattern of the obtained sample was observed with eyes to find that the line pattern was drawn clearly and excellent with little fogging in non-image parts and little contamination with dust in the peripheral parts of the image.

Evaluation of Fogging by Reflectivity

The reflectivity of the non-image parts of the ordinal paper sample and the reflectivity of white paper not subjected to transfer printing were measured by Model 577 manufactured by Photovolt Instruments Inc. to and their difference was calculated to find that the fogging in the non-image parts was as little as 0.4%.

After 50,000 sheets of the paper were subjected to the process, their non-image parts were observed with eyes to find that fogging was occurred by abrasion of the surface of the photoreceptor drum, but would be recovered by replacing the photoreceptor drum with new one.

Further, using the substrate bearing the conductive underlayer, conductive layer formation by electroless copper plating and formation of an insulating layer of epoxy resin particles were carried out using the wiring board production apparatuses shown in FIG. 3 and FIG. 4 and a circuit communication test and an insulation test were carried out to find that there was no problem and that the obtained wiring board was highly reliable.

### EXAMPLE 2

A toner was obtained in the same manner as Example 1, except that the pulverization and sieving conditions of the I type jet pulverizer and DSX sieving apparatus were changed.

The obtained toner was subjected to the particle size distribution measurement similarly to Example 1 to find that the 50% by volume particle diameter was 7.8 μm and the ratio of the fine particles with 4 μm or smaller was 22.0% by number.

The intrinsic volume resistivity was measured similarly to Example 1 to find it was 4.49×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the line pattern was drawn clearly and excellent with little fogging in non-image parts and little contamination with dust in the peripheral parts of the image.

Fogging was evaluated based on reflectivity similarly to Example 1 to find that the fogging in the non-image parts was 0.9%.

Further, after 50,000 sheets of the paper were subjected to the process, their non-image parts were observed with eyes to find that fogging was occurred by abrasion of the surface of the photoreceptor drum, but would be recovered by replacing the photoreceptor drum with new one.

Further, using the substrate bearing the conductive underlayer, conductive layer formation by electroless copper plating and formation of an insulating layer of epoxy resin particles were carried out similarly to Example 1 and a circuit communication test and an insulation test were carried out to find that there was no problem and that the obtained wiring board was highly reliable.

### EXAMPLE 3

A toner was produced in the same manner as Example 1, except that the addition amounts of the thermosetting epoxy resin and the copper particles with 0.6 μm particle diameter were changed to be 30 part by weight and 70 part by weight, respectively.

The obtained toner was subjected to the particle size distribution measurement similarly to Example 1 to find that the 50% by volume particle diameter was 8.1 μm and the ratio of the fine particles with 4 μm or smaller was 14.0% by number.

The intrinsic volume resistivity was measured similarly to Example 1 to find it was 0.8×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the line pattern was drawn clearly and excellent with little fogging in non-image parts and little contamination with dust in the peripheral parts of the image.

Fogging was evaluated based on reflectivity similarly to Example 1 to find that the fogging in the non-image parts was 1.0%.

Further, after 50,000 sheets of the paper were subjected to the process, their non-image parts were observed with eyes to find that the fogging was caused significantly, but would be decreased to the highest possible level of 1.5% by replacing the photoreceptor drum with new one.

Further, using the substrate bearing the conductive underlayer, conductive layer formation by electroless copper plating and insulating layer formation were carried out similarly to Example 1 and a circuit communication test and an insulation test were carried out to find that there was no problem and that the obtained wiring board was highly reliable.

### COMPARATIVE EXAMPLE 1

A toner was obtained in the same manner as Example 1, except that the pulverization and sieving conditions of the I type jet pulverizer and DSX sieving apparatus were changed.

The obtained toner was subjected to the particle size distribution measurement similarly to Example 1 to find that the 50% by volume particle diameter was 7.9 μm and the ratio of the fine particles with 4 μm or smaller was 22.0% by number.

The intrinsic volume resistivity was measured similarly to Example 1 to find it was 0.5×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the dust existing in the peripheral parts of the image rather increased.

Fogging was evaluated based on reflectivity similarly to Example 1 to find that the fogging in the non-image parts was 1.5%.

Further, after 20,000 sheets of the paper were subjected to the process, their non-image parts were observed with eyes to find that the fogging was further increased to the level of 3.0% and not improved by replacing the photoreceptor drum with new one.

Further, using the substrate bearing the conductive underlayer, conductive layer formation by electroless copper plating and formation of an insulating layer of epoxy resin particles were carried out similarly to Example 1 and a circuit communication test and an insulation test were carried out to find that the insulation property was insufficient and thus no sufficient reliability was obtained.

### COMPARATIVE EXAMPLE 2

A toner was produced in the same manner as Example 1, except that the addition amounts of the thermosetting epoxy resin and the copper particles with 0.6 μm particle diameter were changed to be 75 part by weight and 25 part by weight, respectively.

The obtained toner was subjected to the particle size distribution measurement similarly to Example 1 to find that the 50% by volume particle diameter was 8.0 μm and the ratio of the fine particles with 4 μm or smaller was 14.5% by number.

The intrinsic volume resistivity was measured similarly to Example 1 to find it was 0.8×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the line pattern was drawn clearly and excellent with little fogging in non-image parts and little contamination with dust in the peripheral parts of the image.

Fogging was evaluated based on reflectivity similarly to Example 1 to find that the fogging in the non-image parts was 0.2%.

Further, after 50,000 sheets of the paper were subjected to the process, their non-image parts were observed with eyes to find that the fogging was not caused.

Further, using the substrate bearing the conductive underlayer, conductive layer formation by electroless copper plating and insulating layer formation were carried out similarly to Example 1 and a circuit communication test and an insulation test were carried out to find that no sufficient conductivity was obtained.

### COMPARATIVE EXAMPLE 3

A toner was produced in the same manner as Example 1, except that the average particle diameter of the copper particles was changed to be 1.2 μm.

The obtained toner was subjected to the particle size distribution measurement similarly to Example 1 to find that the 50% by volume particle diameter was 8.0 μm and the ratio of the fine particles with 4 μm or smaller was 14.5% by number.

The intrinsic volume resistivity was measured similarly to Example 1 to find it was 2.1×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the dust existing in the peripheral parts of the image rather increased.

Fogging was evaluated based on reflectivity similarly to Example 1 to find that the fogging in the non-image parts was 1.2%.

Further, after 20,000 sheets of the paper were subjected to the process, their non-image parts were observed with eyes to find that fogging was increased very much.

Further, using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

Next, an example of a toner according to the second embodiment of the invention and an example of a method of producing a wiring board according to the fourth embodiment of the invention will be described as follows.

### EXAMPLE 4

The toner particles obtained in the same manner as Example 1 100 part by weight were mixed with silica R 974 (manufactured by Degussa, BET specific surface area 165 m²/g, average particle diameter 12 nm, dimethyldichlorosilane-surface treated) 1 part by weight, silica NAX 50 (manufactured by NIPPON AEROSIL CO., LTD., BET specific surface area 49 m²/g, average particle diameter 35 nm, hexamethyldisilazane-surface treated) 1 part by weight, and zinc stearate (4 μm) 0.2 part by weight by a Henshel mixer for 10 minutes and sieved with 200 mesh to obtain a toner with an average particle diameter of 8.0 μm.

The obtained toner was found similar particle size distribution and 50% by volume particle diameter to those of Example 1.

The intrinsic volume resistivity was measured similarly to Example 1 to find it was 3.0×10¹⁰ Ωcm.

Further, using the obtained toner, similarly to Example 1, a substrate bearing the conductive underlayer and an ordinal paper sample were produced.

The conductive underlayer pattern of the ordinal paper sample was observed with eyes to find that the line pattern was drawn clearly and excellent with little fogging in non-image parts and little contamination with dust in the peripheral parts of the image.

Fogging was evaluated based on reflectivity similarly to Example 1 to find that the fogging in the non-image parts was 0.3% proving that the fogging was further more improved than that in Example 1.

Further, after 50,000 sheets of the paper were subjected to the process, their non-image parts were observed with eyes to find that no adverse phenomenon such as fogging owing to wear of the photoconductor appeared.

Further, using the substrate bearing the conductive underlayer, conductive layer formation by electroless copper plating and insulating layer formation were carried out similarly to Example 1 and a circuit communication test and an insulation test were carried out to find that there was no problem and that the obtained wiring board was highly reliable.

### COMPARATIVE EXAMPLE 4

A toner with an average particle diameter of 8.0 μm was obtained in the same manner as Example 4, except that only silica R974 1 part by weight was used as an external additive.

Further, using the obtained toner, similarly to Example 1, a substrate bearing the conductive underlayer and an ordinal paper sample were produced.

The conductive underlayer pattern of the ordinal paper sample was observed with eyes to find that dust existing in the peripheral parts of the image was slightly much.

Further, fogging was evaluated based on reflectivity similarly to Example 1 to find that the fogging in the non-image parts was 0.9%, which was a rather inferior result.

When the sheets of paper were subjected continuously to the process, their non-image parts were observed with eyes to find that fogging occurred on the 30,000th sheet of paper owing to the wear of the photoconductor. Even if the photoconductor was replaced with new one, the fogging was not suppressed, and the charging capacity of the toner was found decreasing.

Using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

### COMPARATIVE EXAMPLE 5

A toner with an average particle diameter of 8.0 μm was obtained in the same manner as Example 4, except that only silica R974 2 part by weight was used as an external additive.

Further, using the obtained toner, similarly to Example 1, a substrate bearing the conductive underlayer and an ordinal paper sample were produced.

The conductive underlayer pattern of the ordinal paper sample was observed with eyes to find that there was little problem of dust existing in the peripheral parts of the image.

Further, fogging was evaluated based on reflectivity similarly to Example 1 to find that the fogging in the non-image parts was 0.6%, which was slightly inferior.

When the sheets of paper were subjected to the process, life confirmation was carried out to find that charging capacity of the developer was found decreasing at the 10,000th sheet of paper and fogging was significantly increased.

Using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

### COMPARATIVE EXAMPLE 6

A toner with an average particle diameter of 8.0 μm was obtained in the same manner as Example 4, except that only silica NAX50 2 part by weight was used as an external additive.

Further, using the obtained toner, similarly to Example 1, a substrate bearing the conductive underlayer and an ordinal paper sample were produced.

The conductive underlayer pattern of the ordinal paper sample was observed with eyes to find that much dust existed in the peripheral parts of the image.

Further, fogging was evaluated based on reflectivity similarly to Example 1 to find that the fogging in the non-image parts was as high as 1.2%.

Using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

### COMPARATIVE EXAMPLE 7

A toner with an average particle diameter of 8.0 μm was obtained in the same manner as Example 4, except that the particle diameter of the copper particles was changed to be 1.2 μm.

Further, using the obtained toner, similarly to Example 1, a substrate bearing the conductive underlayer and an ordinal paper sample were produced.

The conductive underlayer pattern of the ordinal paper sample was observed with eyes to find that dust existing in the peripheral parts of the image was rather increased.

Further, fogging was evaluated based on reflectivity similarly to Example 1 to find that the fogging in the non-image parts was as high as 1.2%.

After 20,000 sheets of the paper were subjected to the process, their non-image parts were observed with eyes to find that fogging was increased very mach.

Using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

### COMPARATIVE EXAMPLE 8

A toner with an average particle diameter of 8.0 μm was obtained in the same manner as Example 4, except that silica R 972 (manufactured by Degussa, BET specific surface area 135 m²/g, average particle diameter 15 nm, dimethyldichlorosilane-surface treated) was used in place of silica R974.

Further, using the obtained toner, similarly to Example 1, a substrate bearing the conductive underlayer and an ordinal paper sample were produced.

The conductive underlayer pattern of the ordinal paper sample was observed with eyes to find that dust existing in the peripheral parts of the image was rather increased.

Further, fogging was evaluated based on reflectivity similarly to Example 1 to find that the fogging in the non-image parts was as high as 1.1%.

Using the substrate bearing the conductive underlayer, conductive layer formation by electroless copper plating and insulating layer formation were carried out similarly to Example 1 and a circuit communication test and an insulation test were carried out to find that the insulation property was insufficient and no sufficient reliability was obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A toner for manufacturing a wiring board comprising toner particle including a binder resin containing a green thermosetting resin as a main component and 15% to 70% by weight of conductive particles having an average particle diameter of 0.05 μm to 1 μm, wherein 50% by volume particle diameter of the toner is in a range 4 μm to 12 μm and the ratio of the toner with a size of 4 μm or smaller is 20% by number or less.

2. A toner according to claim 1, wherein the conductive particles contain at least one kind of metals selected from a group consisting essentially of copper, nickel, cobalt, silver, palladium, rhodium, gold, platinum and iridium.

3. A toner for manufacturing a wiring board comprising toner particle including:
a binder resin containing a green thermosetting resin as a main component;
15% to 70% by weight of conductive particle having an average particle diameter of 0.05 μm to 1 μm; and
external additives added to a surface of the toner particles containing first metal oxide particle having a BET specific surface area of 150 m²/g to 400 m²/g and treated to be hydrophobic, and second metal oxide particle having a BET specific surface area of 10 m²/g to 70 m²/g and a larger average particle diameter than that of the first metal oxide particles.

4. A toner according to claim 3, wherein the external additives further include a metal soap.

5. A toner according to claim 3, wherein the conductive particles contain at least one metal selected from a group consisting essentially of copper, nickel, cobalt, silver, palladium, rhodium, gold, platinum and iridium.

6. A toner according to claim 3, wherein the addition amount of the first metal oxide particle is 0.3 to 1.5% by weight and the addition amount of second metal oxide particle is 0.5 to 2.0% by weight.

7. A toner according to claim 3, wherein the 50% by volume particle size is 4 μm to 12 μm and the ratio of the toner with a size of 4 μm or smaller is 20% by number or less.

8. A method of manufacturing a wiring board comprising:
forming a toner image by developing an electrostatic latent image using a toner for producing a wiring board comprising toner particles including a binder resin containing a green thermosetting resin as a main component and 15% to 70% by weight of conductive particles having an average particle diameter of 0.05 μm to 1 μm, wherein 50% by volume particle diameter of the toner is in a range 4 μm to 12 μm and the ratio of the toner with a size of 4 μm or smaller is 20% by number or less;
forming a conductive underlayer by transferring the obtained toner image to a substrate and then curing the green thermosetting resin by heating; and
forming a conductive layer by plating the conductive underlayer with a conductive material.

9. A method according to claim 8, wherein the conductive layer is formed by electroless plating or by electroless plating and electrolytic plating in combination.

10. A method of producing a wiring board comprising:
forming a toner image by developing an electrostatic latent image using a toner for manufacturing a wiring board comprising toner particles each including a binder resin containing a green thermosetting resin as a main component; 15% to 70% by weight of conductive particles having an average particle diameter of 0.05 μm to 1 μm; and as external additives added to q surface the toner particles, first metal oxide particles having a BET specific surface area of 150 m²/g to 400 m²/g and treated to be hydrophobic and second metal oxide particles having a BET specific surface area of 10 m²/g to 70 m²/g and a larger average particle diameter than that of the small size metal oxide particles;
forming a conductive underlayer by transferring the obtained toner image to a substrate and then curing the green thermosetting resin by heating; and
forming a conductive layer by plating the conductive underlayer with a conductive material.

11. A method according to claim 10, wherein the conductive layer is formed by electroless plating or by electroless plating and electrolytic plating in combination.

12. A method according to claim 10, wherein the toner for producing a wiring board has 50% by volume particle diameter in a range 4 μm to 12 μm and the ratio of the toner with a size of 4 μm or smaller is 20% by number or less.
